(19) United States
(12) Patent Application Publication
(10) Pub. No.: US 2002/0194070 A1
(43) Pub. Date: Dec. 19, 2002

(54) Placing advertisement in publications

(76) Inventors: Geoffrey Hamilton Totham, Elsternwick (AU); Toby John Ralph, South Yarra (AU)

Correspondence Address: LARSON & TAYLOR, PLC, 1199 NORTH FAIRFAX STREET, SUITE 900, ALEXANDRIA, VA, 22314, US

(21) Appl. No.: 10/148,987

(22) PCT Filed: Dec. 6, 2000
(86) PCT No.: PCT/AU00/01503

(30) Foreign Application Priority Data
Dec. 6, 1999 (NZ) 501600
Aug. 18, 2000 (NZ) 501600

(51) Int. Cl. G06F 17/60

(52) U.S. Cl. 705/14; 707/505

(57) ABSTRACT

An Internet-based method of placing display advertisements in publications, including the step of a facilitator providing an Internet site which can be accessed by advertisers who wish to insert advertisements in publications. Two or more advertisement templates of differing sizes are defined for an advertiser, each advertisement template having a style and appearance approved by or on behalf of the advertiser. When desiring to place an advertisement in a publication, the advertiser accesses the Internet site and selects a publication in which the advertisement is to appear together with size and placement details. The advertiser selects one of the templates which is of a size suitable for placement in the selected publication, and enters details for the advertisement into the template. The advertisement is then forwarded by the facilitator either directly or via an intermediary to the selected publication together with instructions indicating the advertiser's selections.

### FIELD OF THE INVENTION

This invention relates to an Internet-based method of placing advertisements in publications. It relates particularly but not exclusively to a method of placing an advertisement in one or more desired publications over the Internet, including using a template to create the layout for the advertisement.

### BACKGROUND OF THE INVENTION

In a typical transaction in which an advertiser places a display advertisement in a publication, there are numerous steps. Firstly, the advertiser identifies the publication(s) in which to place the advertisement and the desired size of the advertisement. The advertiser then telephones an advertising agency to request price details. The agency then prepares a media schedule which indicates costings for the proposed advertisement, and faxes it to the advertiser.

The advertiser then confirms (or changes) the booking with the agency, and the agency books space for the advertisement with the publication(s). The advertiser types out the “copy” for the advertisement and faxes it to the agency. The agency re-types the advertisement on a typesetting machine, and submits a proposed layout to the advertiser. The advertiser makes amendments to the layout and faxes it back to the agency. The agency prepares the final advertisement and faxes it to the advertiser. The advertiser confirms the final proof and faxes formal approval to the agency. The agency sends the final advertisement to the publication(s), who place the advertisement and send an account to the agency. The agency then sends an account to the advertiser together with a “tearsheet” copy of the advertisement.

It will readily be appreciated that this method of placing advertisements is relatively inefficient. In particular, there is a significant lead time involved in accomplishing all of the steps, and there is a significant cost to the advertiser in the correspondence with the agency.

Similar difficulties are encountered with regard to many different forms of publications required by organisations. The problems are particularly acute in the case of large organisations which have multiple offices or franchises. In such cases, it is desirable to maintain a consistent organisational image throughout organisational documents, and this requires constant supervision and checking of proposed documents such as letterheads, business cards, advertising material, signs, and newsletters.

Recent advances in technology have meant that it is increasingly common for orders for goods to be placed over the Internet. Some publications, such as the Sydney Morning Herald and the Melbourne Trading Post, have made it possible for potential advertisers to submit classified advertisements directly over the Internet. In such cases, the publication provides on its web site a page at which the intending advertiser can type in the copy for the proposed advertisement. Subject to satisfactory payment methods being arranged, and to the advertisement complying with applicable laws and the publication's guidelines, the advertisement is then inserted in the publication as a line advertisement.

In some cases, the advertiser can request, for an additional charge, a minor variation such as a bold heading. However, the advertiser does not have control over the typeface, font size, graphic appearance or layout of the advertisement. These characteristics of a line advertisement are determined by the publication's standard appearance. Accordingly, the intervention of an advertising agency in preparing the advertisement has usually been considered unnecessary for classified advertisements, and the advertiser frequently deals directly with the publication. In most cases, classified advertisements are placed by the advertiser sending the “copy” to the publication by mail or fax. The publication then typesets the advertisement, and the advertiser does not get an opportunity to review the advertisement before it is published.

In the case of display advertisements, a more elaborate procedure is justified because the advertiser needs some assurance that the appearance of the advertisement will be acceptable. Merely typing the copy into an Internet web page associated with the publication is not sufficient, because it does not give the advertiser adequate assurance with regard to appearance. Usually, an advertiser prefers to develop a “corporate style” which applies to all advertisements associated with that advertiser. A “corporate style” typically consists of a set of rules applying to the appearance of the advertisements, including such features as typefaces, font sizes, colours, appearance and relative locations of graphic elements, text and images, and other similar features. Ordinarily, the advertising agency is responsible for developing and/or maintaining the “corporate style” rules for an advertiser; hence the complicated steps in placing a display advertisement through an advertising agency, as outlined above.

Moreover, the Internet sites which allow placement of classified advertisements in a publication do not allow the placement of one advertisement in multiple publications (although some publish the advertisement on a web site as well as in a printed publication), and they do not provide comparisons of the benefits of advertising in different publications, in the way that an advertising agency provides these benefits.

### SUMMARY OF THE INVENTION

According to a first aspect of the invention, there is provided an Internet-based method of placing display advertisements in publications, including the following steps:

(a) a facilitator provides an Internet site which can be accessed by advertisers who wish to insert advertisements in publications;

(b) two or more advertisement templates of differing sizes are defined for an advertiser, each advertisement template having a style and appearance approved by or on behalf of the advertiser;

(c) when desiring to place an advertisement in a publication, the advertiser accesses the Internet site and selects a publication in which the advertisement is to appear together with size and placement details;

(d) the advertiser selects one of the templates which is of a size suitable for placement in the selected publication, and enters details of the advertisement into the template; and

(e) the advertisement is then forwarded by the facilitator either directly or via an intermediary to the selected publication together with instructions indicating the advertiser's selections.

The advertiser preferably uses the advertiser's computer as a remote terminal to access the Internet site across the Internet.

The step of entering details of the advertisement into the template may be accomplished in any suitable manner. Preferably, it involves the sub-steps:

(a) the advertiser downloads the template from the Internet site to the advertiser's computer;

(b) the advertiser enters details of the advertisement into the template on the advertiser's computer; and

(c) the advertiser uploads the completed advertisement to the Internet site.

Thus the amending is preferably done on the advertiser's computer, rather than on the remote Internet site.

The Internet site may be designed in any suitable way, and may provide to the visitor any suitable information. In a preferred embodiment, the Internet web site further includes data concerning the available advertisement types, sizes and prices for the publications into which advertisements may be placed. The site is designed in such a way that the choice of templates presented to the advertiser after a particular publication has been selected is a group of templates which match the advertisement types and sizes available in that publication.

It will be appreciated that the invention affords the advertiser an opportunity to reduce lead time on advertisements and to reduce costs. The costs of an advertisement may be billed to the advertiser in any suitable way. In a preferred arrangement, after the advertiser has entered details of the advertisement, an account for the cost of the advertisement is automatically generated and forwarded to the advertiser.

The step of the advertiser entering details of the advertisement may be accomplished in any suitable manner. It may simply involve entering text, and using graphics associated with the predefined template. Alternatively, it may involve the advertiser uploading one or more images for use in the advertisement.

As a further alternative, the step of the advertiser entering details of the advertisement may include the advertiser selecting and placing in the advertisement clip-art, text, uploaded images and/or other design elements in accordance with a range of design constraints specified by the template. This gives the advertiser flexibility in designing the advertisement, while ensuring that the final advertisement complies with the advertiser's “corporate style” and has an acceptably professional appearance (because it complies with the guidelines provided by the template), without having to consult a graphic artist.

As a further feature, the Internet web site may be designed in such a way that the prices and/or other information which an advertiser sees when accessing the Internet web site are individually tailored to that particular advertiser, reflecting any pricing agreements which may exist between the advertiser and the publication(s) and between the advertiser and the facilitator. This enables the advertiser to take into account, for example, any volume discounts to which the advertiser may be entitled by reason of the amount of advertising being placed through a particular publication.

The publication or publications to which the invention applies may be any suitable type of publication. Suitable types of publication include, in particular, the following:

(a) Newspapers;

(b) Magazines;

(c) Journals;

(d) Catalogues;

(e) Directories; and

(f) Other forms of printed publications.

The system on which the inventive method operates preferably allows users to search the database for previous advertisements by search criteria such as placement date, publication or client, etc. It also preferably allows advertisements to be warehoused for final approval by a supervisor or a manager prior to final dispatch to the publication.

The system also preferably allows the user to format text i.e. font size, style, bold, italics etc, or alternatively lock these facilities if the advertiser is concerned that the user's autonomy may risk a departure from the advertiser's corporate style.

As an additional feature, the inventive method may include a facility for designing and ordering documents, including the following steps:

(a) One or more document templates are defined for each advertiser, each document template having a style and appearance approved by or on behalf of the advertiser;

(b) When desiring to design and order a document, an advertiser accesses the Internet web site, selects one the advertiser's templates, and enters or amends the document contents within the template; and

(c) The document design is then forwarded by the facilitator either directly or via an intermediary to a printer, signwriter or other document producer.

This method can be used for preparing any suitable type of document. Suitable types of documents include the following:

(a) business stationery;

(b) a sign;

(c) a leaflet or brochure.

Preferably, the Internet web site further includes data concerning available document types, quantities and prices.

According to a further optional feature of the invention, there may be provided an additional facility for laying out newsletters or parts of newsletters, including the following steps:

(a) One or more newsletter templates are defined for each advertiser, each newsletter template having a style and appearance approved by or on behalf of the advertiser, and partially pre-written content provided by a newsletter writer;

(b) When desiring to lay out a newsletter, an advertiser accesses the Internet web site, selects one of the advertiser's newsletter templates, and enters or uploads one or more newsletter articles into the template; and

(c) The newsletter layout and content is then forwarded by the facilitator either directly or via an intermediary to a printer for printing.

### BRIEF DESCRIPTION OF THE DRAWINGS

The invention will hereinafter be described in greater detail by reference to the attached drawings which show an example form of the invention. It is to be understood that the particularity of those drawings does not supersede the generality of the preceding description of the invention.

FIG. 1 is a flow chart illustrating the process flows for an embodiment of the invention.

FIG. 2 is a schematic diagram showing the system of FIG. 1 from the point of view of the client application.

FIG. 3 shows an opening screen for an embodiment of the invention.

FIG. 4 shows a welcome screen requesting a password or client code entry for the embodiment of FIG. 3.

FIG. 5 shows a second welcome screen and disclaimer for the embodiment of FIG. 3.

FIG. 6 shows third welcome screen indicating the user has successfully logged on for the embodiment of FIG. 3.

FIG. 7 shows a welcome screen providing an overview of the services offered for the embodiment of FIG. 3.

FIG. 8 shows a task page screen for the embodiment of FIG. 3, assuming newspaper advertising is selected in FIG. 7.

FIG. 9 shows a regional area selection screen for the embodiment of FIG. 3.

FIG. 10 shows a publication selection screen for the embodiment of FIG. 3.

FIG. 11 shows a template editing screen for the embodiment of FIG. 3.

FIG. 12 shows a “Graphics ready for use” screen which provides images for use in the advertisement by the client for the embodiment of FIG. 3.

FIG. 13 shows a selected template in a proprietary word processor which allows the client to amend text in the advertisement.

FIG. 14 illustrates the interaction between the template and the proprietary word processor by way of a dialog box.

FIG. 15 shows a screen which enables the client to save the advertisement.

FIG. 16 shows a screen which enables the client to make special booking instructions and to code a particular advertisement.

FIG. 17 shows a confirmation page which allows the client to amend or duplicate the advertisement.

FIG. 18 shows a thank you screen which advises the client that the booking is complete and a confirmation email is to be forwarded.

FIG. 19 illustrates email confirmation of the advertising booking, and a representation of the advertisement which has been placed, in pdf format.

FIG. 20 shows a list of advertisements which have already been placed using the embodiment of FIG. 3. FIG. 21 is a screen which displays the graphics which are currently available for use in the embodiment of FIG. 3.

FIG. 22 illustrates a list of graphics which are stored on the client's computer.

FIG. 23 shows a screen which allows the client to order a professional graphic for use in an advertisement.

FIG. 24 shows a screen which lists advertising bookings which have not been approved for publishing.

FIG. 25 shows a search page allowing the client to search for previous used advertisements.

FIG. 26 illustrates a booking report which lists advertisements which have been previously booked and placed by the user.

FIG. 27 shows a printed product task page for the embodiment of FIG. 3.

FIG. 28 shows a signs task page for the embodiment of FIG. 3.

FIG. 29 shows a print advertising task page for the embodiment of FIG. 3.

### DETAILED DESCRIPTION

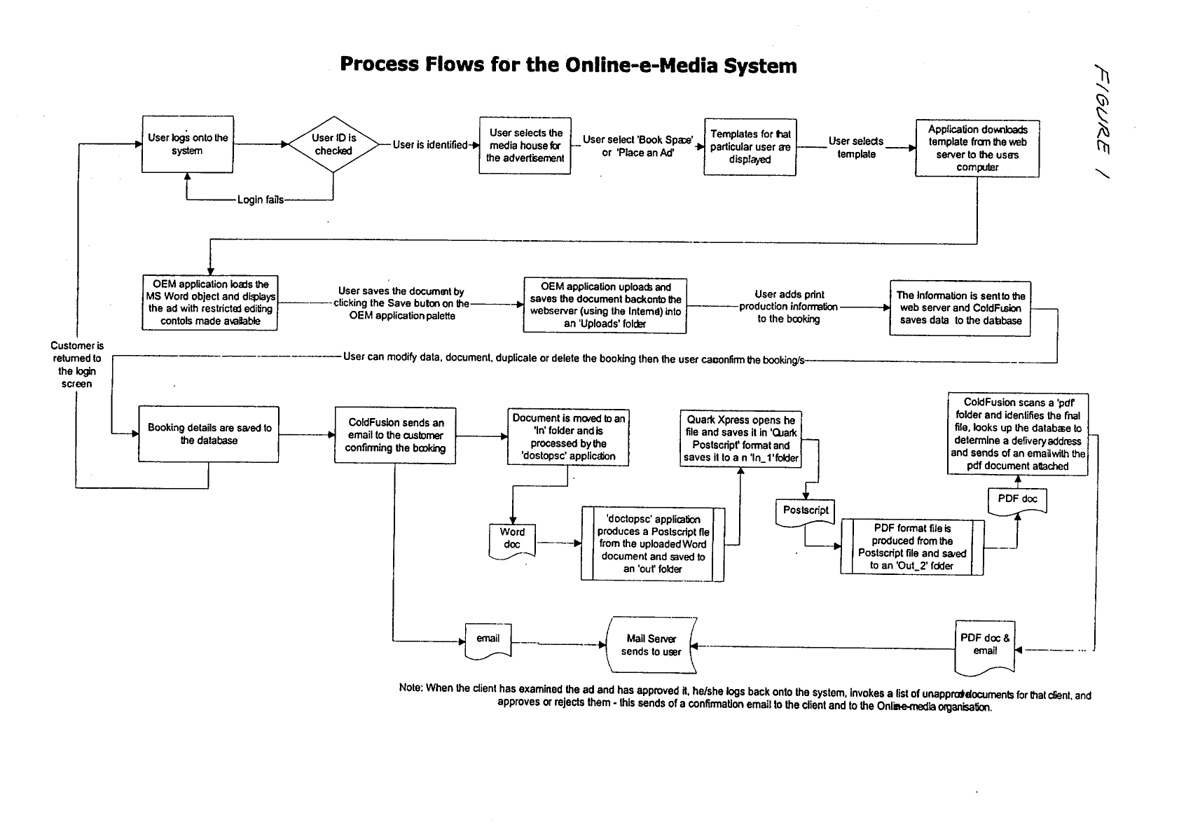

FIG. 1 shows a process according to an embodiment of the invention from beginning to end, from the point of view of the background processing. Starting at the top left hand side of the diagram, the user logs on to the system. The User ID is checked, the user is identified, and the user selects the media house for the advertisement. The user may select “book space” or “place an advertisement”. Templates for the user are then displayed; the user selects a template, and the application downloads the template from the web server to the user's computer.

A software application loads proprietary document editing software which is installed on the client's computer and displays the advertisement with restricted editing controls made available. The user saves the document, and the application uploads and saves the document back to the web server (using the Internet) into an “uploads” folder. The user adds print production information to the booking; this information is sent to the web server and saved into a database.

The user can modify the data or document, or duplicate or delete the booking; then the user can confirm the booking. The booking details are saved to the database, an email confirmation is sent to the customer, and the document is then processed into an appropriate format from a word processing document to a Postscript format and a PDF (Adobe Portable Document File) format. The PDF file is then sent to the user, who logs back on to the web server and approves or rejects the advertisement. This action results in another email being sent to the user.

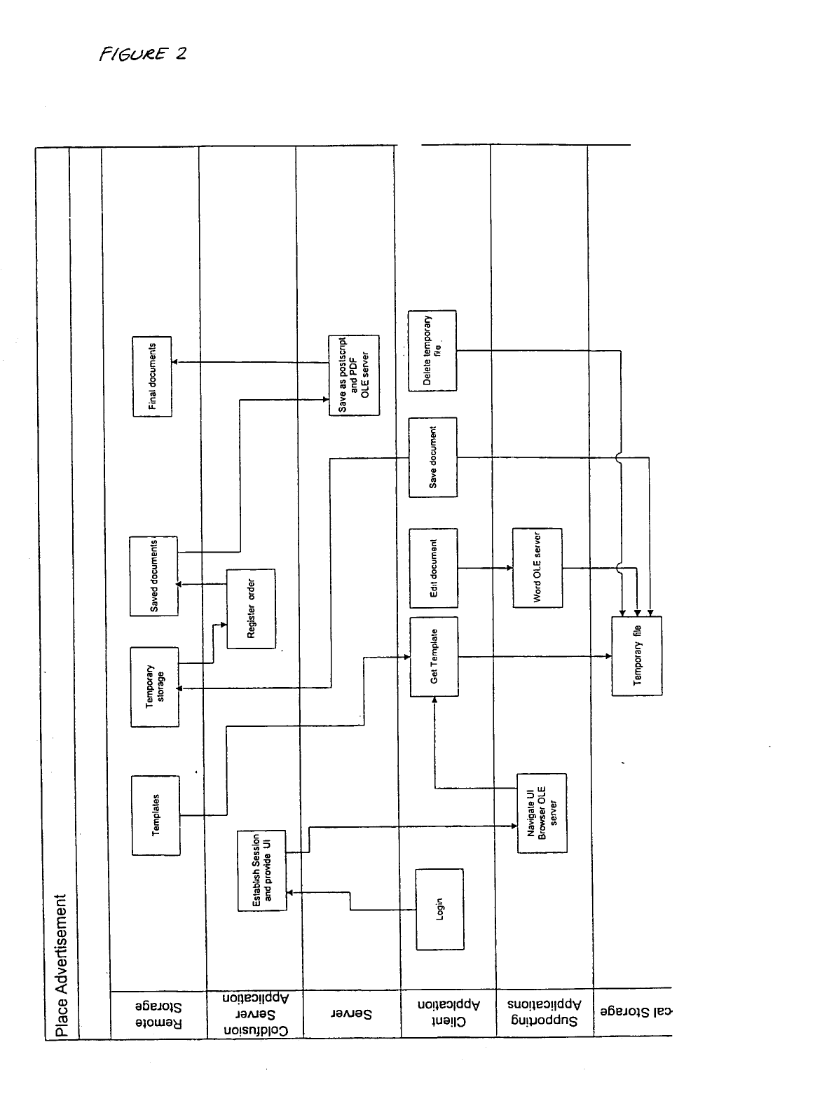

FIG. 2 illustrates the system from the point of view of the application which the client installs on the client's computer. Firstly, the client application logs in to the server application, which establishes the session and provides the user interface. Web browser and navigation software which has been installed on the client computer provides for navigation of the user interface. The client application gets a template from remote storage associated with the server and stores it in a temporary file in local storage. A word processor application operating on the client computer provides for editing of the temporary file. The client application then provides for saving of the document, which results in deletion of the temporary file and uploading of the saved document to temporary storage on the server. The document is then used to register the order, then saved in Postscript and PDF versions to produce the final documents.

The flowcharts of FIGS. 1 and 2 are specific to the advertisement aspect of the invention. Similar information flows apply to other aspects of the invention such as newsletter creation, stationery design, and signage design.

Referring now to FIGS. 3 to 14, there are shown the screens which, according to an example embodiment of the invention, an advertiser encounters when placing an advertisement or requesting a publication. FIG. 3 shows the “home page” screen, which is encountered when a client who wishes to place an advertisement or request a publication first runs the application on the client's computer. In order to proceed, the client selects the “Connect” icon which is illustrated near the top left hand corner of the screen.

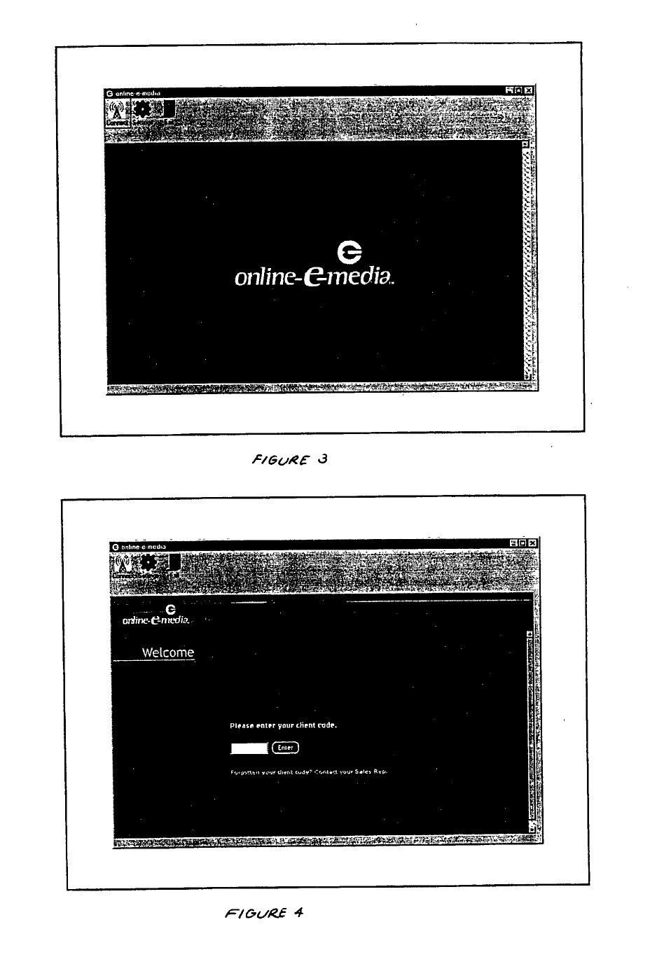

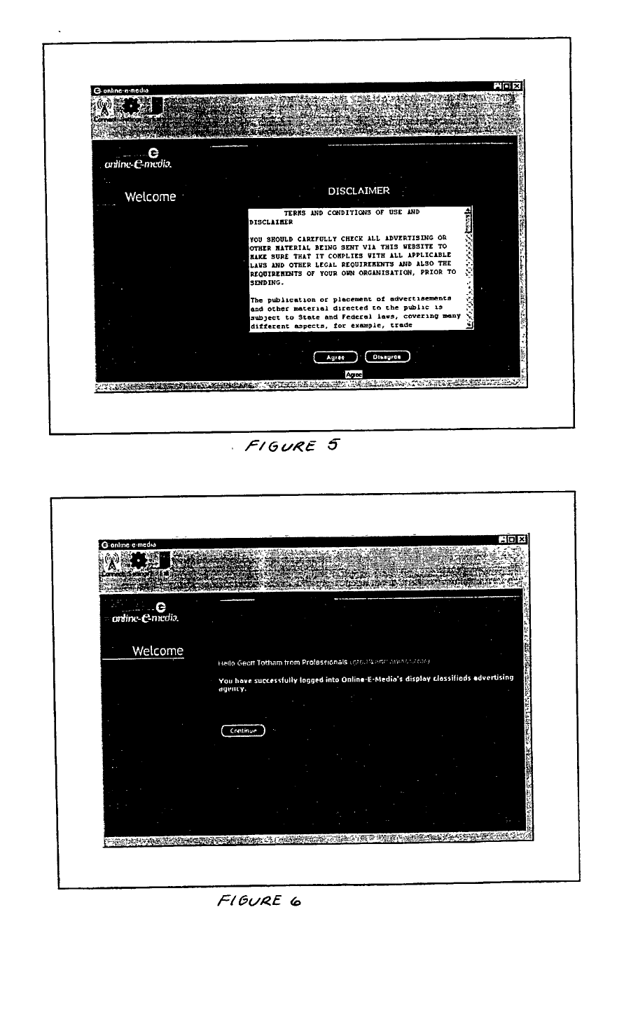

This results in an Internet connection being established, and the screen of FIG. 4 being displayed. The client types in the applicable client code and selects “Enter”. In this embodiment of the invention it is necessary for the client to be registered and allocated a client code before the booking process can proceed. If the client successfully enters a client code, the screen of FIG. 5 is displayed, providing the terms and conditions of use of the system and a disclaimer for the client to read prior to using the system to place an advertisement. If the client selects the “Agree” button on the screen of FIG. 5, the client will be presented the welcome screen illustrated in FIG. 6 where the client is advised that they have successfully logged on to the system. The client then selects “Continue” to begin the process of placing an advertisement. If the client does not agree to the terms and conditions of use of the system and they select the “Disagree” button, they will exit the program.

FIG. 7 is a final welcome screen which enables the user to select from the selection of services that the system offers which includes:

(a) printed products e.g. business stationary and flyers;

(b) signs;

(c) newspaper advertising;

(d) print advertising e.g. magazines and trade journals.

In a preferred embodiment of the invention, users of the system which are not registered clients with a client code may obtain more information about the services provided by the system and register to use the system by selecting the “overview” hypertext link. Users or clients of the system are also able to contact the system proprietors for technical support preferably by email, although facsimile and postal details may also be provided.

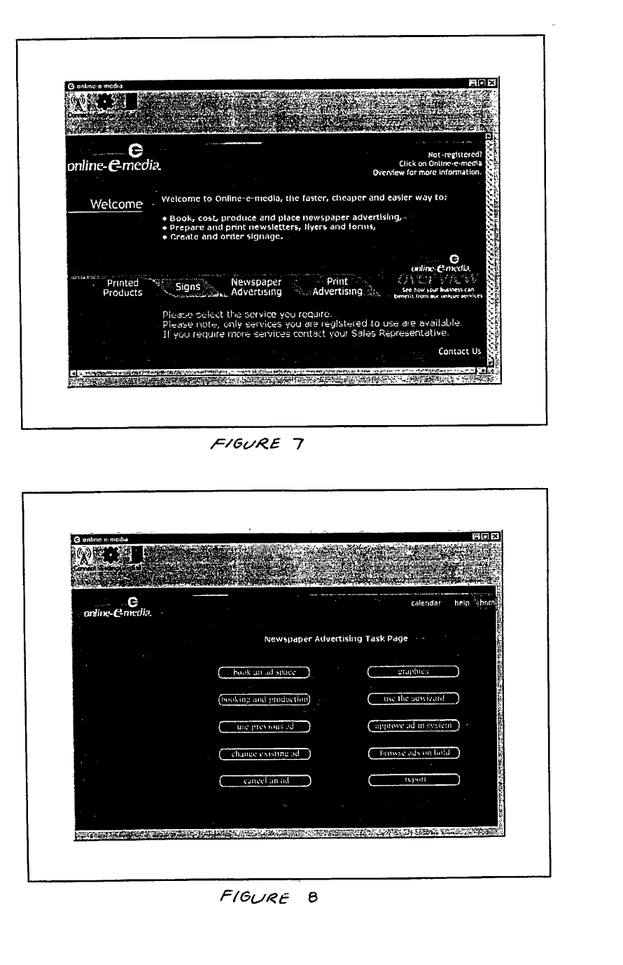

If the client elects to publish an advertisement in a newspaper by selecting “Newspaper Advertising”, a newspaper advertising task page is displayed as illustrated in FIG. 8. This provides the client with several options which relate to placing an advertisement in a newspaper which include but are not limited to:

(a) book an ad space;

(b) booking and production;

(c) use previous ad;

(d) change existing ad;

(e) cancel an ad;

(f) graphics;

(g) use the ad wizard;

(h) approve an ad in the system;

(i) browse ads on hold;

(j) report.

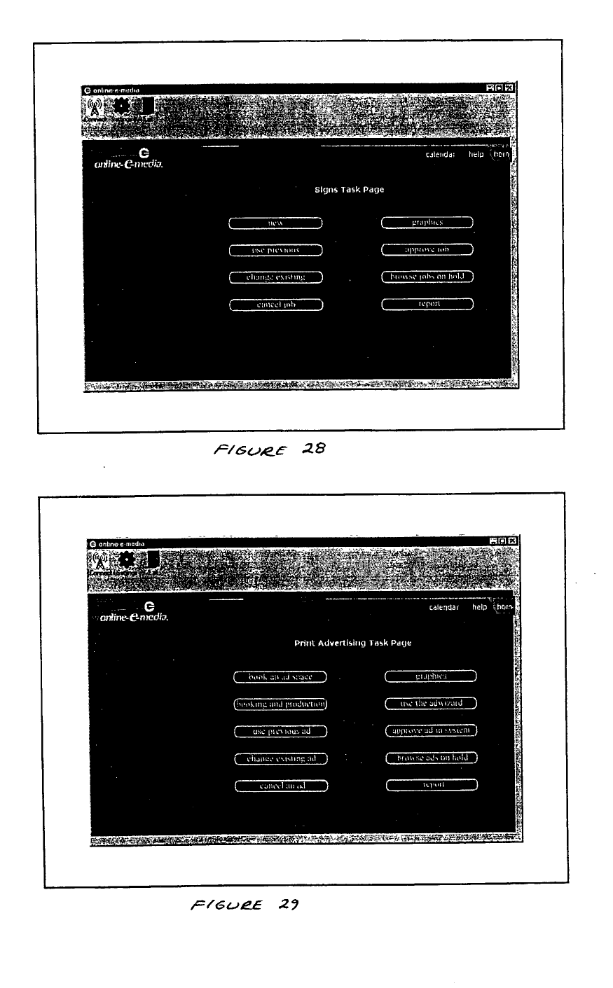

Similarly, if the client elects to publish a printed product, a sign or an advertisement in a particular print advertiser, the client is presented with the screens illustrated in FIG. 27 which shows a printed products task page, FIG. 28 which shows a signs task page and FIG. 29 which shows a print advertising task page wherein the client is offered appropriate services and options.

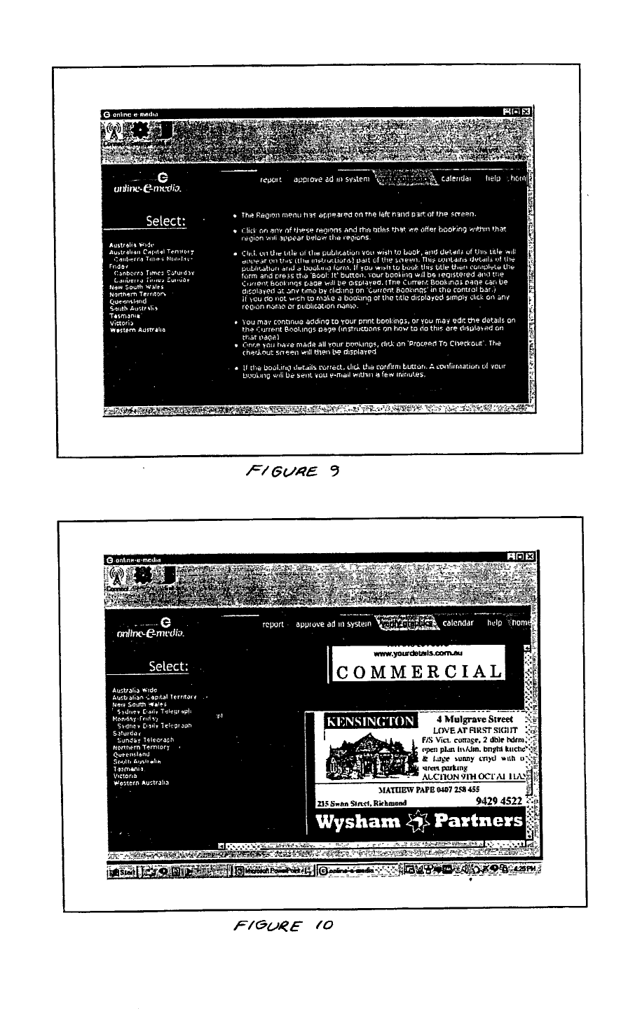

In this embodiment of the invention, the client elects to place an advertisement in a newspaper and selects booking and production from the screen shown in FIG. 8. A regional area list is then displayed as in FIG. 9, which enables the client to select a particular geographical demographic in which the advertisement will be placed. At the left hand side of the screen there is a list of regions, in this case consisting mostly of States of Australia and latest news about the service and instructions for use further to the right of the screen. In a preferred embodiment of the invention, the client is presented with a list of the newspaper titles in which advertisements may be placed by placing the selection tool (e.g. the mouse pointer) over the regional area, with out clicking or selecting that area. The client is then able to choose a particular newspaper by making a selection (i.e. clicking on a title) or the client may review other newspaper titles which are available in another geographical area by moving the selection tool over a different regional area which is listed. In this example, the client elects to place a newspaper advertisement in the Canberra Times Saturday newspaper.

The client is then presented with the screen shown in FIG. 10 which illustrates the different size templates which are available for use by the client. These templates have been designed previously by a graphic designer in order to ensure that any advertisement created using one of the templates reflects the corporate style of the client and complies with the design rules governing that corporate style. Each of the templates also has an indicative costing for the proposed advertising placement. In a preferred embodiment of the invention, a particular publication may specify standard templates which are available in that particular publication.

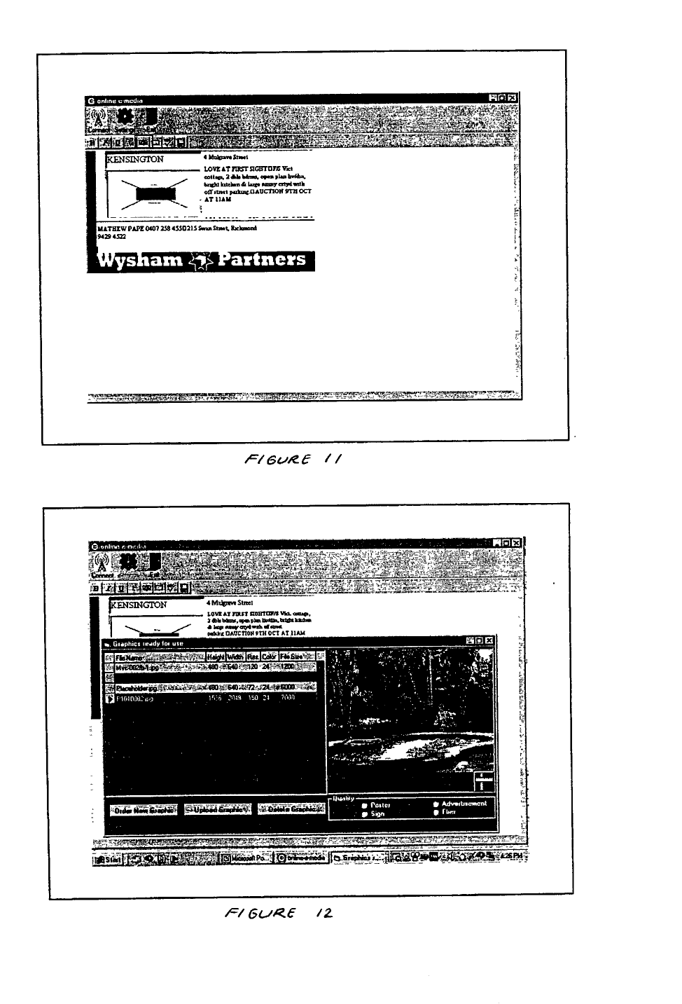

When the user selects the particular template which they wish to use for their advertisement, the applicable template is downloaded to the client's computer, whereafter the screen of FIG. 11 is displayed. This is in fact a document in a proprietary word processing software format which automatically opens on the client's computer. The client types into the appropriate spaces or amends the copy for the advertisement, while the choice of style and overall appearance is constrained by the template. The client accesses this image library by clicking on the camera icon in the toolbar which is preferably at the top of the screen, and which displays a “graphics ready for use” screen as shown in FIG. 12.

The graphics ready for use screen enables the client to select images which are to be inserted into an advertisement. The system allows the user to select the image quality required by specifying the end product which the image will be used for, which is a newspaper advertisement in this example, but which may also include posters, signs and flyers. The user can also crop the image to an appropriate size by selecting the “rulers” icon which is located in the bottom right corner of the image in this embodiment of the invention.

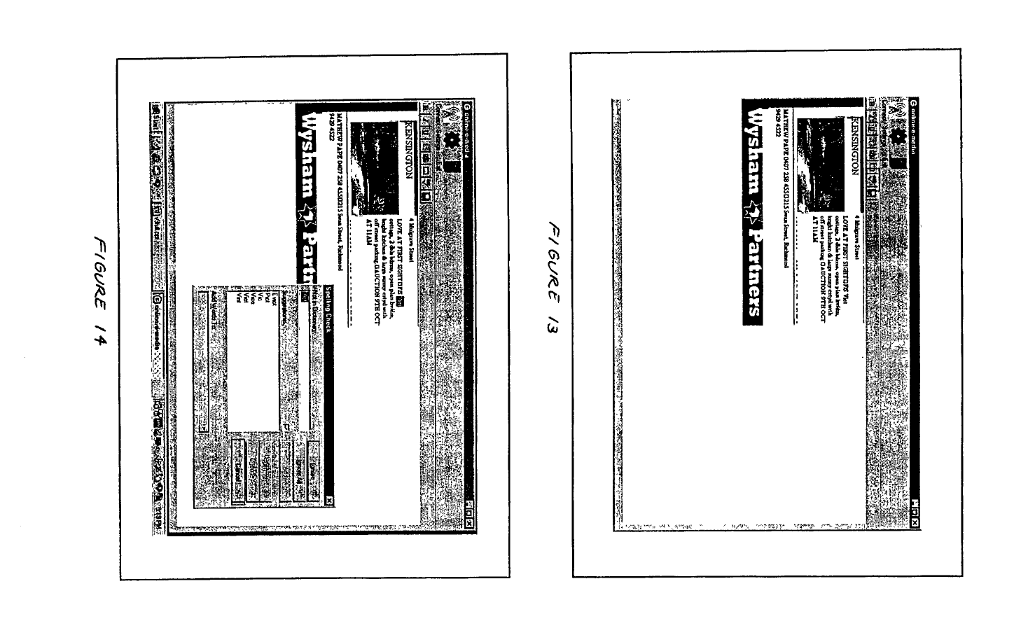

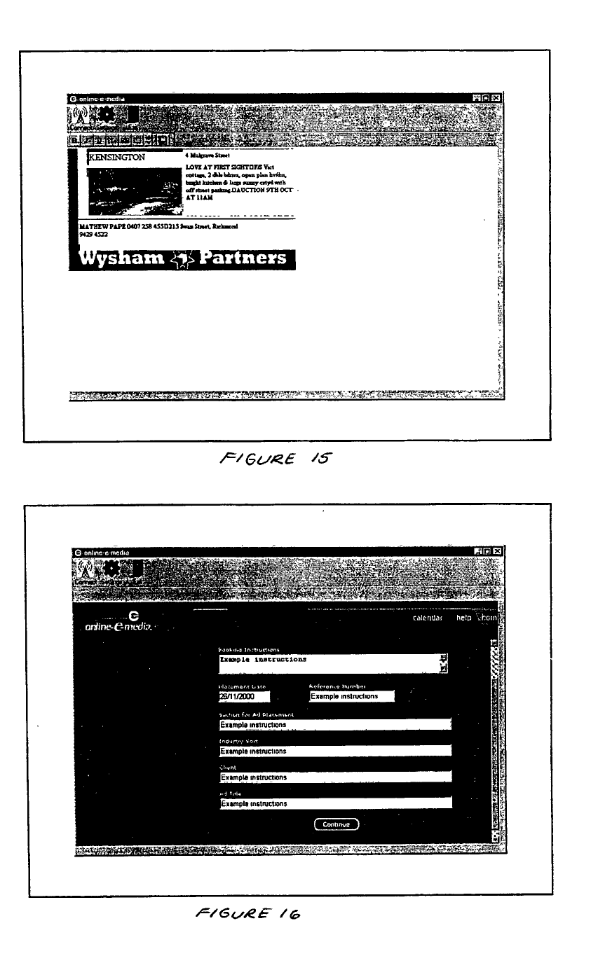

The screen shown in FIG. 13 illustrates the way in which the content which the client has placed into the template can be checked for spelling errors using the proprietary word processor. FIG. 14 is a further illustration of this. FIG. 15 illustrates the way in which the client saves the advertisement onto the system server by selecting the “Save” icon which is located on the tool bar along the top of the screen. This results in the amended document being automatically uploaded to the web server.

FIG. 16 allows the client to specify special booking instructions which may include:

(a) the placement date;

(b) a reference number;

(c) the section of the newspaper in which the advertisement is to be placed;

(d) the industry involved;

(e) the name of the client;

(e) the name of the advertisement.

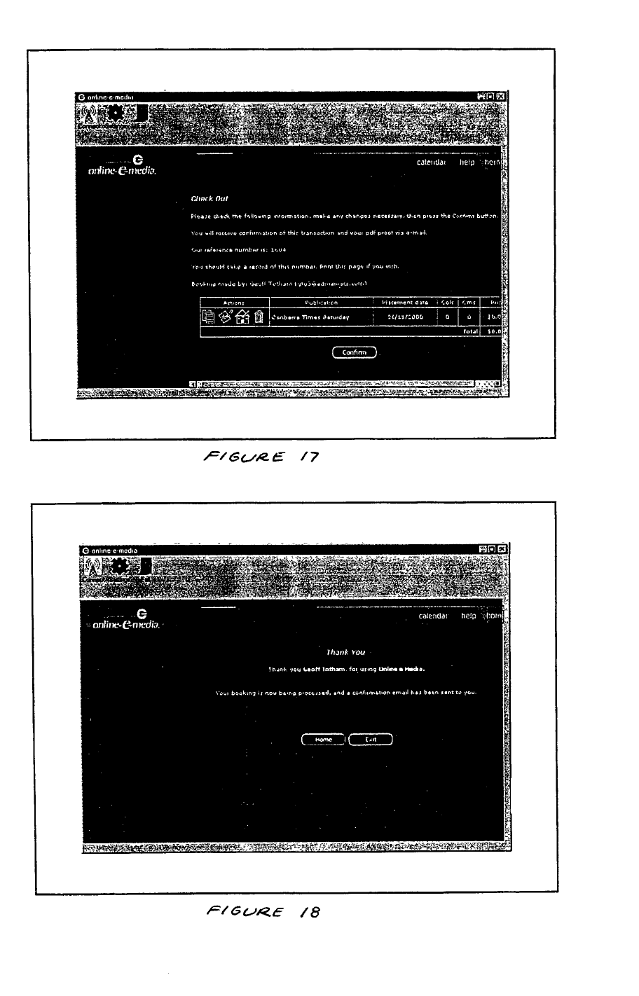

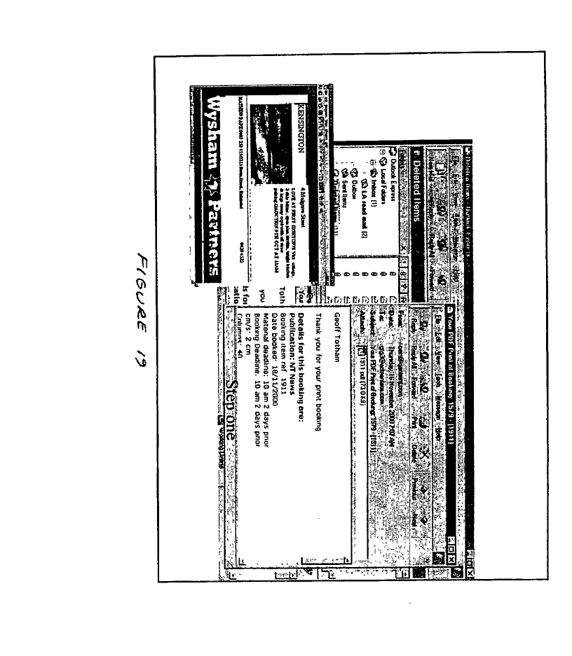

When the client selects “Continue” on the screen of FIG. 16, the screen shown in FIG. 17 is presented, wherein the client is prompted the check the instructions which have been entered for the advertisement, and to make any corrections or amendments which may be necessary. The client is also given the opportunity to copy or duplicate the advertisement for placement in another publication and to confirm the instructions for the present booking. When the instructions are confirmed on the screen of FIG. 17, the client is presented with the screen shown in FIG. 18, wherein the client is thanked for using the service and is advised that their booking is being processed and a confirmatory email will be generated and forwarded to the client's email address. FIG. 19 illustrates an example of an email confirmation of the advertising booking which is emailed to the client, and a representation of the advertisement which has been placed, in pdf format, which is preferably attached to the email for final approval by the client.

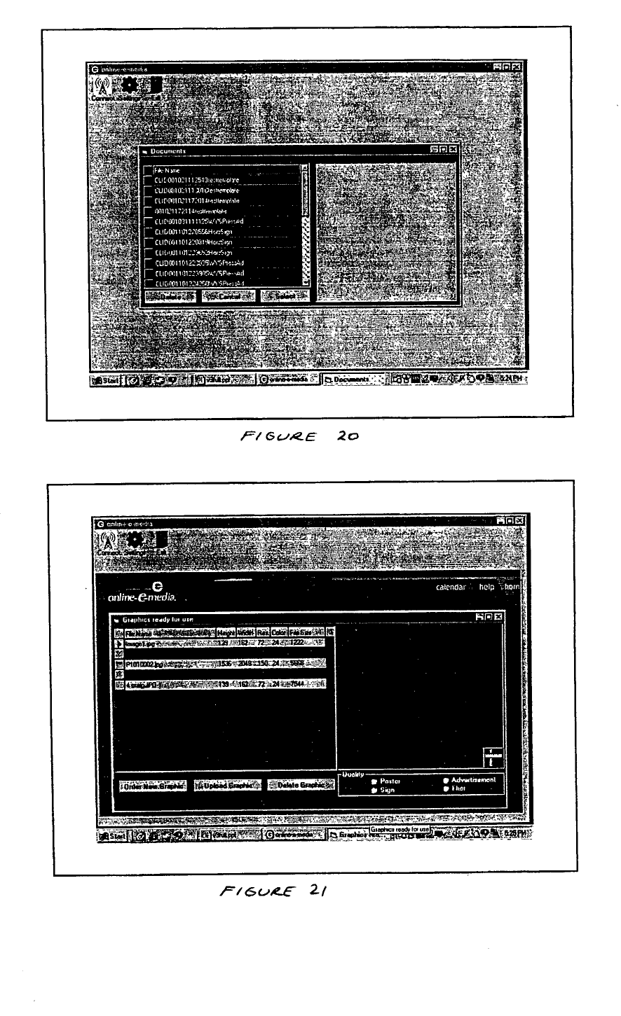

The screen shown in FIG. 20 displays a list of titles of advertisements which have previously been generated and saved using the system. It is preferred that advertisements generated using the system may be archived on the system server for up to two years, enabling the client to keep a record of advertisements which have been made. This also reduces the amount of time which is required to create two similar advertisements, as the client can re-run the same advertisement or an amended version of it more than once.

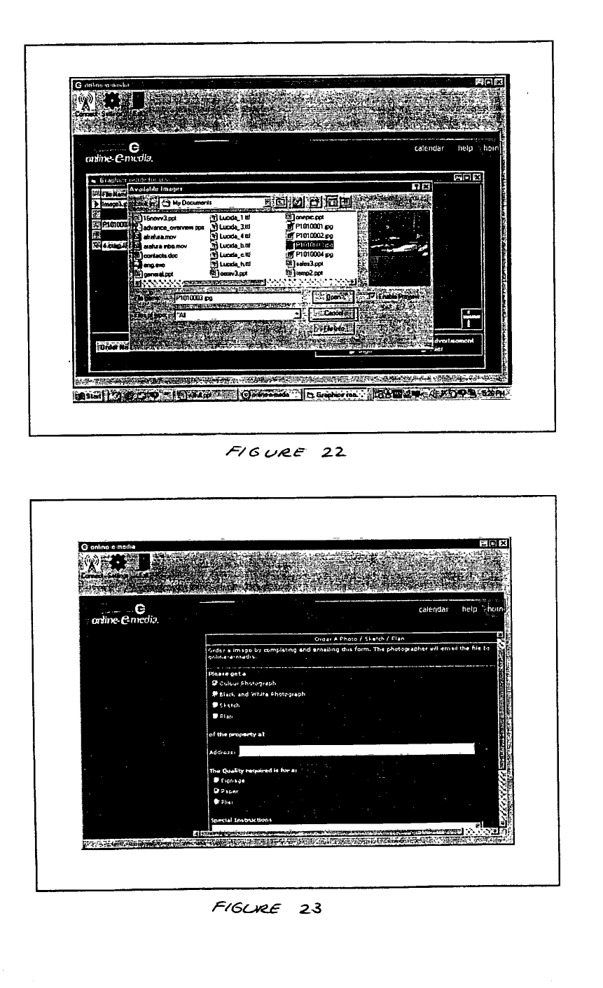

The screen shown in FIG. 21 lists graphics which are currently available on the system server, while the screen shown in FIG. 22 lists graphics which are available on the client's computer. Graphics which are saved on the client's computer can be uploaded to the system server by selecting the “Upload Graphics” button which is available on the screen shown in FIG. 12. FIG. 23 shows a screen through which the client orders photographs, sketches or plans from a third party; this screen is accessible by selecting the “Order New Graphic” button also available on the screen shown in FIG. 12.

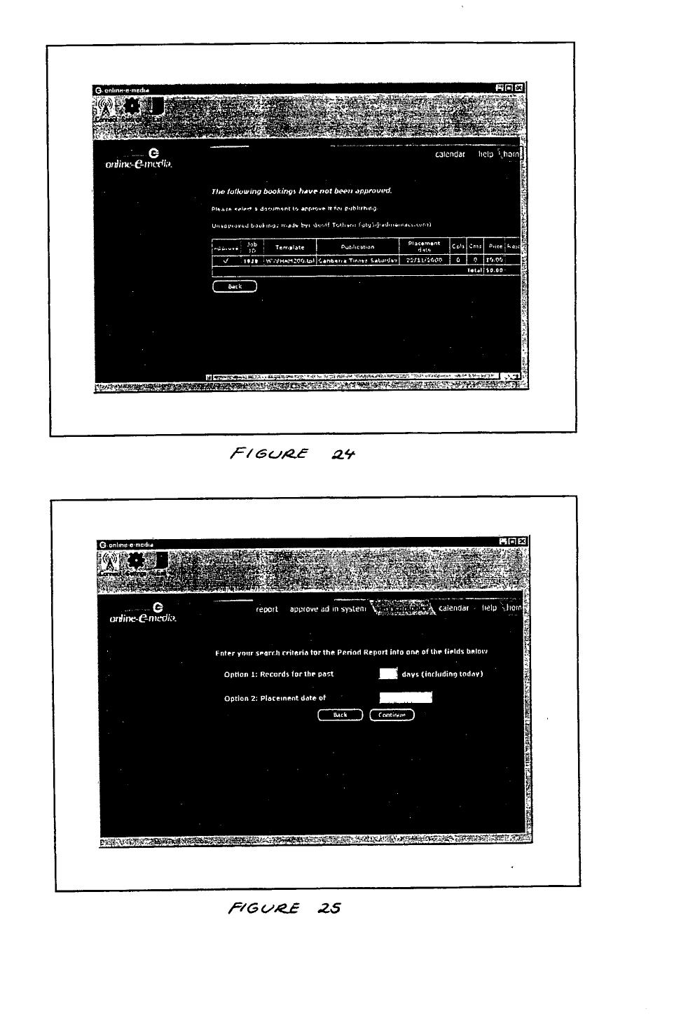

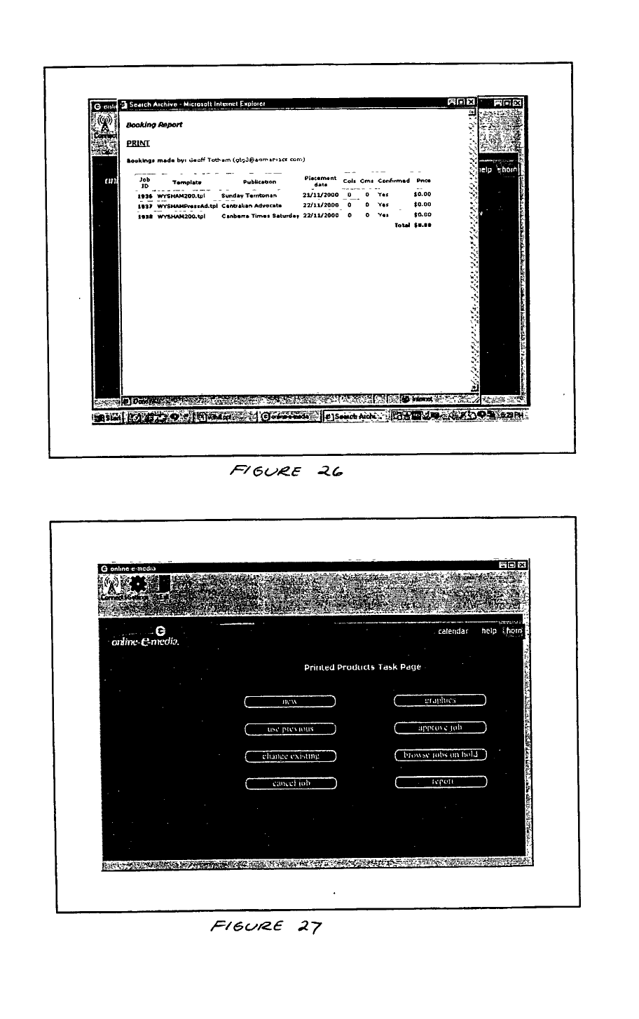

FIG. 24 shows a screen wherein bookings which have not yet been approved for publishing are listed. Here, the client is given an opportunity to approve or reject an unapproved booking, with the appropriate authorization. This screen can be accessed by selecting “Approve Advertisement” which is available in the screen which is shown in FIG. 8. FIG. 25 shows a screen which enables the client to search the system server for advertisements which have been placed previously, depending on particular search criteria. This search criteria includes but is not limited to searching records for the last predetermined number of days, or searching for advertisements placed on a particular date. FIG. 26 shows a list of advertisements which have been previously booked and placed by the client, including details of the advertisement such as a reference number, the publication and placement date, the price of the advertisement and the template used.

As will readily be appreciated, a similar editing and placement method applies for ordering other documents such as stationery, signage and newsletters over the Internet using the website illustrated in FIG. 4. For example, by selecting the “Others” option in FIG. 2, the client may, after passing through appropriate preliminary screens, be presented with the stationery design templates of FIG. 14. The client selects the applicable template, downloads and edits it, saves and uploads the edited version, specifies the quantities required, and waits for the printed items to arrive. By selecting the “Signage” option in FIG. 4, the client may choose to lay out one or more signs, and by selecting the “Newsletters” option, the client may choose to upload articles for inclusion in a newsletter.

One aspect of the invention provides a unique Internet enabled solution to the production of newsletters and in-house publications. A “master” newsletter can be prepared using quality journalism on lead articles. Typically these articles might be run on a national, international or corporate scale. As part of the template, individual clients would not be able to alter these stories.

A series of more local stories (typically on a Statewide or countrywide or divisional or interest group basis) can then be inserted in the template. If a country has say 15 States or provinces, there might, for example, be 15 of these stories, one per area. These stories are locked in to the template for that area, and cannot be changed by individual clients. Thus in this example there are 15 templates, with one common national story but 15 Statewide stories. All these are automatically available to a local user.

Underneath this are some changeable stories or blank columns or advertising. These are sections of the template that can be changed by individual users once they have logged on and given their individual user number. Thus if there are say 100 offices in each of 15 States, there will be one national story, 15 Statewide stories and 1500 individual stories which vary by office.

This method enables a high quality newsletter to be produced simply and inexpensively, with local content. Industry specific newsletters can also be created and held as templates, thus offering small enterprises a high quality low cost option for newsletter production. Similar benefits apply for magazines and in-house publications for large organisations such as global corporations.

Another specific application of the invention is in Yellow Pages directory entry placement. In the US, there are several thousand different Yellow Pages telephone directories, with different deadlines and advertising costs. The present invention allows a directory sales person, for example, to typeset, cost and book several advertisements for a customer directly at the point of sale. One particular difficulty with telephone directories is in placing advertisements for large organisations consisting of independent franchises. The inventive method could overcome this difficulty by permitting individual franchisees to log on to a web site, select from a menu the regions pertinent to their franchises, view a list of relevant directories which is then provided, select a predefined template from a range of available templates specified by the controlling franchisor, type in the variable components of the advertisement (such as address and telephone number), obtain a quote, and book the advertisement.

In order to create an embodiment of the invention, there was a requirement for an application which would enable the user to navigate a website, download and modify a template and submit it to a remote server using the web. To provide a wide range of editing facilities in a familiar environment a template was used which was developed using proprietary word processing software. To avoid needing to have additional ports open in firewalls and to simplify installation only hftp was used for any data exchange.

Although the basic functionality for doing this is available using word processing and Internet browsing software packages which are currently available, using these applications would require a fair amount of expertise on the part of the user, would require the use of macros in the templates, presents the associated risks of virus infection, and leaves scope for errors.

Basically the user would navigate to the page in the browser and click on a link to a template which would then open in the browser. After editing the template the user would need to save a copy giving it a unique filename and taking note of the location. The user would then double click on a macro button in the document and on the next page he would click another control and recalling the name and location of the file saved submit it to the server.

During this procedure a number of dialog boxes could be presented by the system depending on the order in which things happened. The correct answer to at least one of these would be counter-intuitive. At any stage the user could navigate to a page out of sequence in the browser or select the wrong document or simply forget the next step.

The user would also need to manually delete the temporary files that would otherwise accumulate on the user's local hard disk. The presence of these could also be confusing in following sessions.

To eliminate these problems in the initial implementation, a new application was developed to simplify the user interface and eliminate most possible reasons for error. The application creates objects that make use of the OLE server capabilities of proprietary word processing software to provide basic editing and browsing capabilities while itself handling the user interface and enabling data to be transferred without user interaction, something that for security reasons is not possible using a standard web browser. The application also performs some housekeeping chores and can potentially maintain a local database relating to interactions with the web server. A separate OLE server resides on the server site and handles the conversion of file formats.

The system uses a number of applications which are tied together to form an unique ‘whole’. In use are: MS Internet Information Server, ColdFusion Server, Quark Xpress, 4th Dimension (the multiuser database server with its ODBC driver interface for ColdFusion), AppleScript, web pages written using HTML, JavaScript and ColdFusion tags, Acrobat Exchange and the custom OEM doctopsc applications and proprietary word processing package. The ways these interact are shown in FIGS. 1 and 2.

It is to be understood that various alterations, additions and/or modifications may be made to the parts previously described without departing from the ambit of the invention.

1. An Internet-based method of placing display advertisements in publications, including the following steps:
(a) a facilitator provides an Internet site which can be accessed by advertisers who wish to insert advertisements in publications;
(b) two or more advertisement templates of differing sizes are defined for an advertiser, each advertisement template having a style and appearance approved by or on behalf of the advertiser;
(c) when desiring to place an advertisement in a publication, the advertiser accesses the Internet site and selects a publication in which the advertisement is to appear together with size and placement details;
(d) the advertiser selects one of the templates which is of a size suitable for placement in the selected publication, and enters details of the advertisement into the template; and
(e) the advertisement is then forwarded by the facilitator either directly or via an intermediary to the selected publication together with instructions indicating the advertiser's selections.

2. A method according to claim 1 wherein the advertiser uses the advertiser's computer to access the Internet site, wherein further the step of entering details of the advertisement into the template involves the sub-steps:
(a) the advertiser downloads the template from the Internet site to the advertiser's computer;
(b) the advertiser enters details of the advertisement into the template on the advertiser's computer; and
(c) the advertiser uploads the completed advertisement to the Internet site.

3. A method according to claim 1 or claim 2 wherein the Internet web site further includes data concerning the available advertisement types, sizes and prices for the publications into which advertisements may be placed, and wherein further the choice of templates presented to the advertiser after a particular publication has been selected is a group of templates which match the advertisement types and sizes available in that publication.

4. A method according to any one of claims 1 to 3 wherein, after the advertiser has entered details of the advertisement, an account for the cost of the advertisement is automatically generated and forwarded to the advertiser.

5. A method according to any one of claims 1 to 4 wherein the step of the advertiser entering details of the advertisement includes the advertiser uploading one or more images for use in the advertisement.

6. A method according to any one of claims 1 to 4 wherein the step of the advertiser entering details of the advertisement includes the advertiser selecting and placing in the advertisement clip-art, text, images and/or other design elements in accordance with a range of design constraints specified by the template.

7. A method according to claim 2 wherein the prices and/or other information which an advertiser sees when accessing the Internet web site are individually tailored to that particular advertiser, reflecting any pricing agreements which may exist between the advertiser and the publication(s) and between the advertiser and the facilitator.

8. A method according to any one of claims 1 to 7 wherein the publication or publications are one or more of the following types:
(a) Newspapers;
(b) Magazines;
(c) Journals;
(d) Catalogues;
(e) Directories; or
(f) Other forms of printed publications.

9. A method according to any one of claims 1 to 8 further including a facility for designing and ordering documents, including the following steps:
(a) One or more document templates are defined for each advertiser, each document template having a style and appearance approved by or on behalf of the advertiser;
(b) When desiring to design and order a document, an advertiser accesses the Internet web site, selects one of the advertiser's templates, and enters or amends the document contents within the template; and
(d) The document design is then forwarded by the facilitator either directly or via an intermediary to a printer, signwriter or other document producer.

10. A method according to claim 9 wherein the document is one of the following types of documents:
(a) business stationery;
(b) a sign;
(c) a leaflet or brochure.

11. A method according to any one of claims 1 to 10 further including a facility for laying out newsletters or parts of newsletters, including the following steps:
(a) One or more newsletter templates are defined for each advertiser, each newsletter template having a style and appearance approved by or on behalf of the advertiser, and partially pre-written content provided by a newsletter writer;
(b) When desiring to lay out a newsletter, an advertiser accesses the Internet web site, selects one of the advertiser's newsletter templates, and enters or uploads one or more newsletter articles into the template; and
(c) The newsletter layout and content is then forwarded by the facilitator either directly or via an intermediary to a printer for printing.
